(19) United States
(12) Patent Application Publication
(10) Pub. No.: US 2022/0327511 A1
(43) Pub. Date: Oct. 13, 2022

(54) SYSTEM AND METHOD FOR ACQUIRING TRAINING DATA OF PRODUCTS FOR AUTOMATED CHECKOUT

(71) Applicant: Vcognition, Inc., San Francisco, CA (US)

(72) Inventors: Motilal Agrawal, San Carlos, CA (US); Krishna Motukuri, San Mateo, CA (US); Abhinav Katiyar, Sunnyvale, CA (US)

(73) Assignee: Vcognition, Inc., San Francisco, CA (US)

(21) Appl. No.: 17/225,004

(22) Filed: Apr. 7, 2021

(51) Int. Cl. G06Q 20/20; G06N 3/04; G06N 20/00

(52) U.S. Cl. CPC G06Q 20/208; G06N 3/0454; G06N 20/00

(57) ABSTRACT

The present system configures an automated checkout system for acquiring training data and automatically captures training data using multimodal sensing techniques. The training data can then be used to train a learning model, such as for example a deep learning model with multiple neural networks. The trained learning model may then be applied to users interacting with product display units within a store.

### BACKGROUND

### 1. Field of the Invention

The invention relates to acquiring training data to train a learning machine. In particular, acquiring product training data for training a learning machine to achieve automated checkout.

### 2. Background and Description of the Related Art

Systems exist for the purpose of trying to provide automated checkout within a store. These systems have several issues. Some of the issues are related to training and modeling products for recognition by automated checkout systems. For example, some systems send a product to be scanned, modeled three dimensionally, and generate synthetic data. Processing the scanned, modeled, or synthetic data, however, is not as accurate as modeling the product itself. Other systems collect images of the product and mark the product by hand in each frame in which the product appears. This method for identifying a product is very time-consuming and requires extensive user resources. Other systems tally a customer's receipts at a point of sale to indicate that a customer has picked these items. The disadvantage with this system is that it does not truly confirm what or when a user picked from the aisles of the store. What is needed is an improved system for training a learning machine for automated checkout.

### SUMMARY

The present technology, roughly described, automatically acquires training data products for automated checkout. The present system configures an automated checkout system for acquiring training data and automatically captures training data using multimodal sensing techniques. The training data can then be used to train a learning model, such as for example a deep learning model with multiple neural networks. The trained learning model may then be applied to users interacting with product display units within a store.

There are several benefits to the present technology with respect to the prior art. For example, videos are automatically collected when a person interacts with a product display unit. The video includes ground truth data for the time, quantity, product identifier (for example, an SKU), and location. The training data can be representative of an actual in-store condition and performs better for testing than other methods. Because of the in-store conditions, the videos are more realistic than those that are generated using synthetic rendering.

In some instances, a method for acquiring training data of products for automated checkout begins with receiving a plurality of weight values by a computing device and from a weight sensing mechanism coupled to a product display unit. Each of the plurality of weight values associated with a time stamp and a change in the number of products are stored on the product display unit. The method continues with receiving a plurality of video data sets by the computing device and from one or more cameras, wherein each video data set having a time stamp that is synchronized with one of the weight value time stamps. Additionally, each video data set captures the location on the product display unit that is associated with the change in the number of products stored on the display unit. A computing device determines, for each weight value, the quantity of products removed or added to the display unit based at least in part on the weight value. The plurality of weight values, plurality of video data sets, and product quantities removed or added are intended to be used for training a learning machine.

In some instances, a computer readable medium stores code that, when executed, performs a similar method.

In some instances, a system for acquiring training data of products for automated checkout includes a server having memory, a processor, and one or more modules. The one or more modules can be stored in the memory and executed by the processor to receive a plurality of weight values by a computing device and from a weight sensing mechanism coupled to a product display unit, each of the plurality of weight values associated with a time stamp and a change in the number of products stored on the product display unit. receive a plurality of video data sets by the computing device and from one or more cameras, each video data set having a time stamp that is synchronized with one of the weight value time stamps, and each video data set capturing the location on the product display unit that is associated with the change in the number of products stored on the display unit, determine, by the computing device and for each weight value, the quantity of products removed or added to the display unit based at least in part on the weight value, wherein the plurality of weight values, plurality of video data sets, and product quantities removed or added are intended to be used for training a learning machine.

### BRIEF DESCRIPTION OF FIGURES

FIG. 1 illustrates an example configuration of product display units with different products, weight sensing mechanisms, and one or more cameras.

FIG. 2A illustrates an example configuration of a product display unit with designated lanes.

FIG. 2B illustrates an example configuration of a product display unit with clusters of cameras.

FIGS. 2C-2E illustrate cameras that capture a lane from different points of view.

FIG. 2F illustrates an example configuration of a product display unit that includes cameras and a motion sensor.

FIG. 2G illustrates another example configuration of a product display unit that includes cameras and emotion sensor.

FIG. 3 is a block diagram of a training data acquisition system.

FIG. 4 is a block diagram of a data collection server.

FIG. 5 is a block diagram of a model training server.

FIG. 6 is a block diagram of a data store.

FIG. 7 is a method for acquiring training data for an automatic checkout system.

FIG. 8 is a method for configuring an automated checkout system for acquiring training data.

FIG. 9 is a method for capturing training data using multi modal sensing.

FIG. 10 is a method for training a deep learning model using captured training data.

FIG. 11 is a method for applying a trained deep learning model to video of users interacting with product display units.

FIG. 12 is a screenshot of a dashboard for building a planogram.

FIG. 13 is a screenshot of an interface for marking lanes via annotation.

FIG. 14 is a screenshot of a dashboard for calibrating product display unit sensitivity.

FIG. 15 is a block diagram of an environment for implementing the present technology.

### DETAILED DESCRIPTION

The present system automatically acquires training data of products for automated checkout. The present system configures an automated checkout system for acquiring training data and automatically captures training data using multimodal sensing techniques. The training data can then be used to train a learning model, such as for example a deep learning model with multiple neural networks. The trained learning model may then be applied to users interacting with product display units within a store.

There are several benefits to the present technology with respect to the prior art. For example, videos are automatically collected when a person interacts with a product display unit. The video includes ground truth data for the time, quantity, product identifier (for example, a SKU), and location. The training data can be representative of an actual in-store condition and performs better for testing than other methods. Because of the in-store conditions, the videos are more realistic than those that are generated using synthetic rendering.

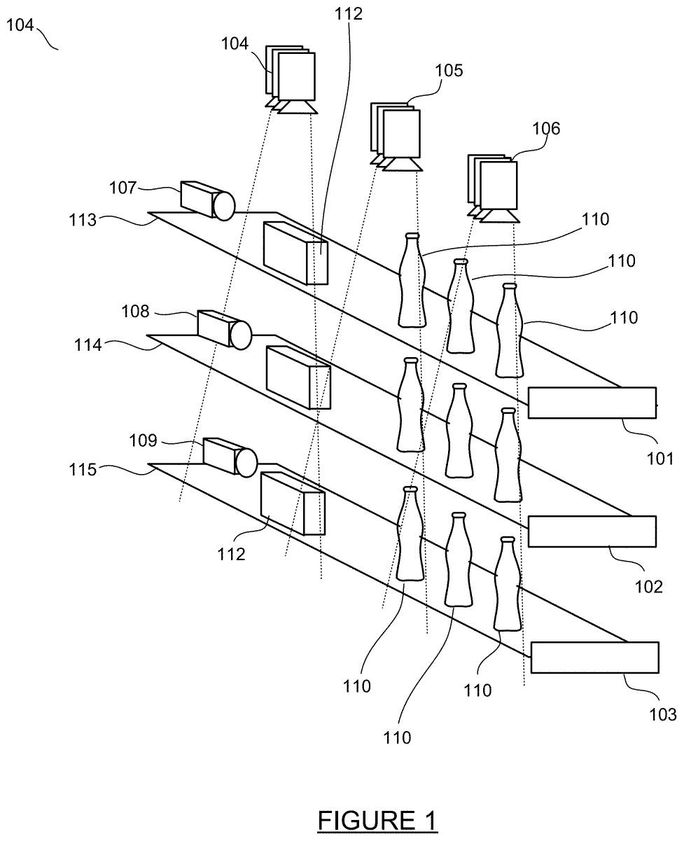

FIG. 1 illustrates an example configuration of product display units with different products, weight sensing mechanisms, and one or more cameras. The system of FIG. 1 includes weight sensing mechanisms 101, 102, and 103, overhead cameras 104, 105 and 106, lateral cameras 107, 108, and 109, first products 110, second products 112, and product display units 113, 114 and 115.

The product display units may be any unit that can support a product, such as for example a shelf. Each product display unit 113-115 may support or hold a number of products, such as products 110 and 112. Each product may have a different weight, such that product 110 may have a different weight than product 112. Weight sensing mechanisms 101-103 may detect the total weight on display units 113-115, respectively. As a product is removed from a particular product display unit, a corresponding weight sensing unit coupled to or incorporated within the product display unit will detect the change in weight. The weight sensing unit may also send a message to a computing device indicating that a change in weight has been detected. When a change in weight has been detected, a timestamp is recorded by the weight sensing device and sent with the notification to the computing device.

Overhead cameras 104-106 may capture the product display surface of each product display unit as well as the vicinity around the display units. Similarly, each lateral camera 107, 108, and 109 can capture one shelf each, and collectively capture the space over all three product display units. Hence, cameras 104-106 and cameras 107-109 capture videos of all the products on product display units 107-109, but from different angles. In some instances, additional cameras may also capture video of one or more locations on the product display units, but are not shown in FIG. 1.

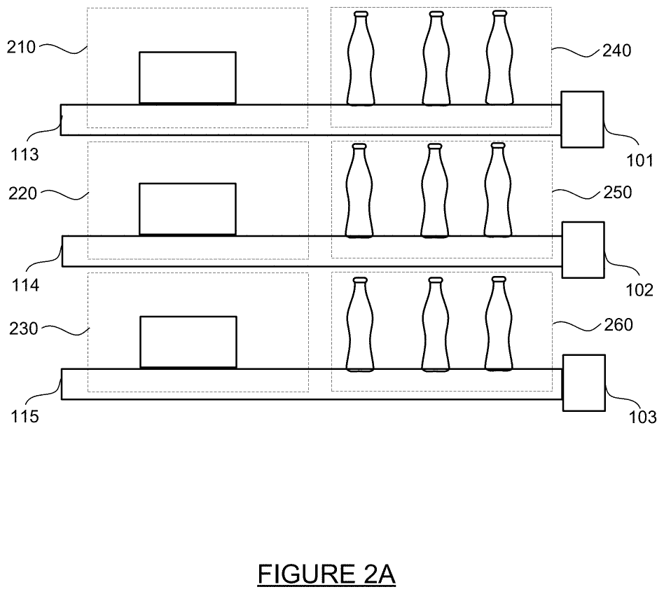

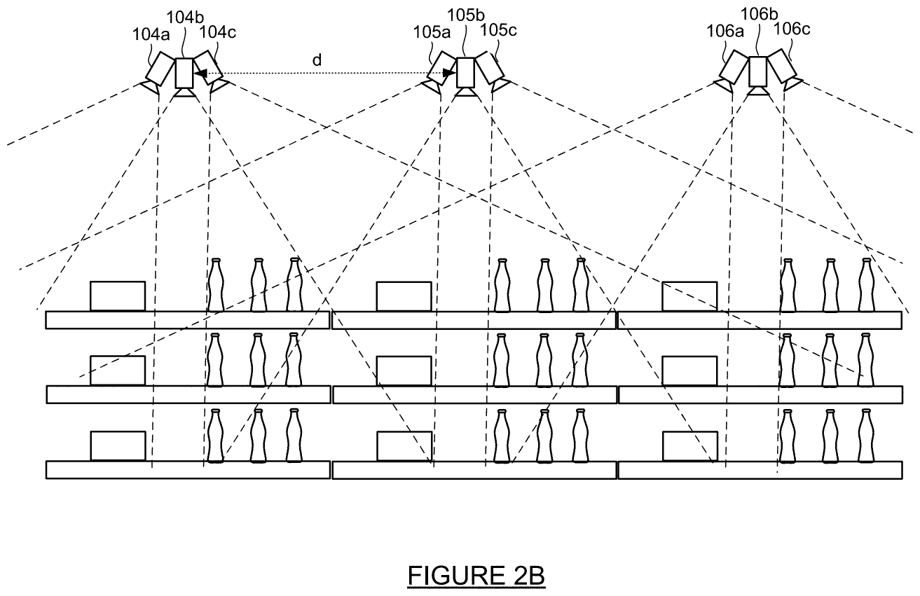

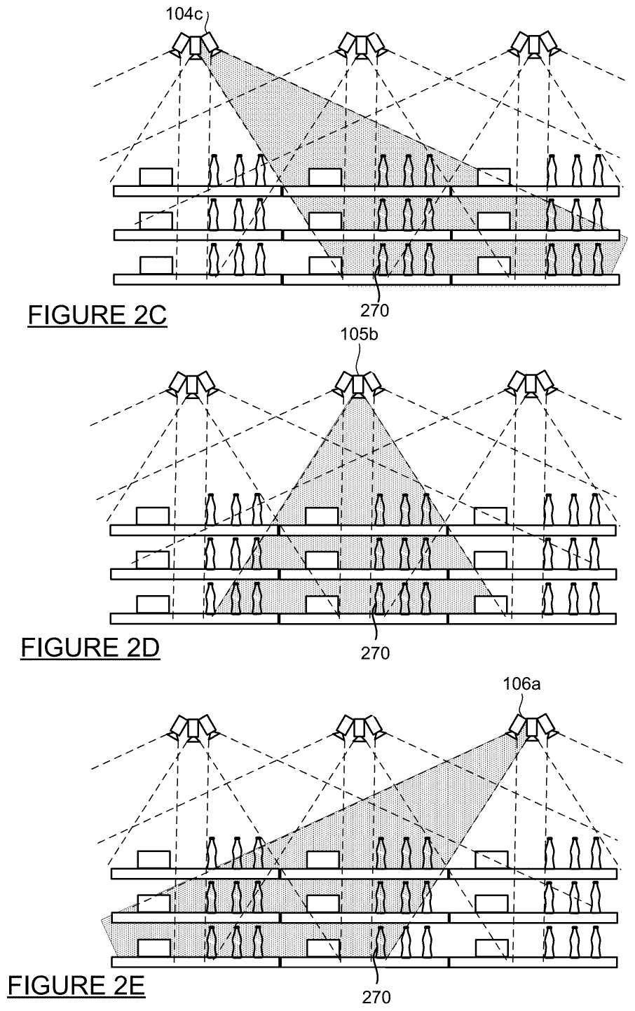

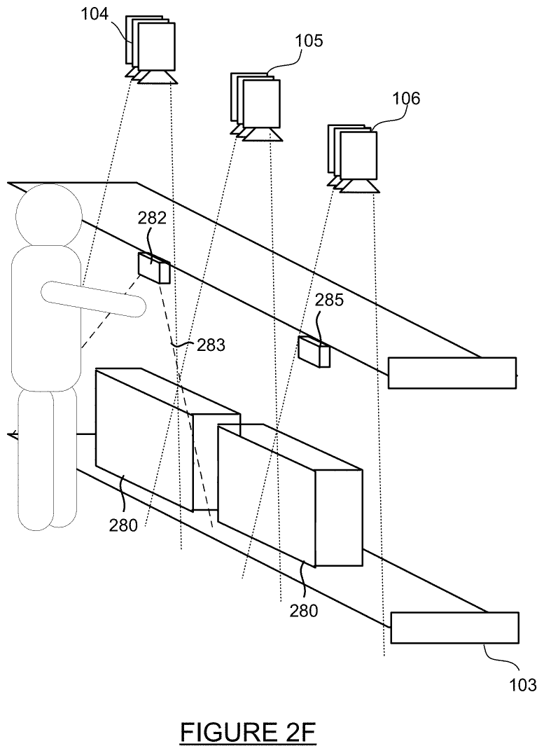

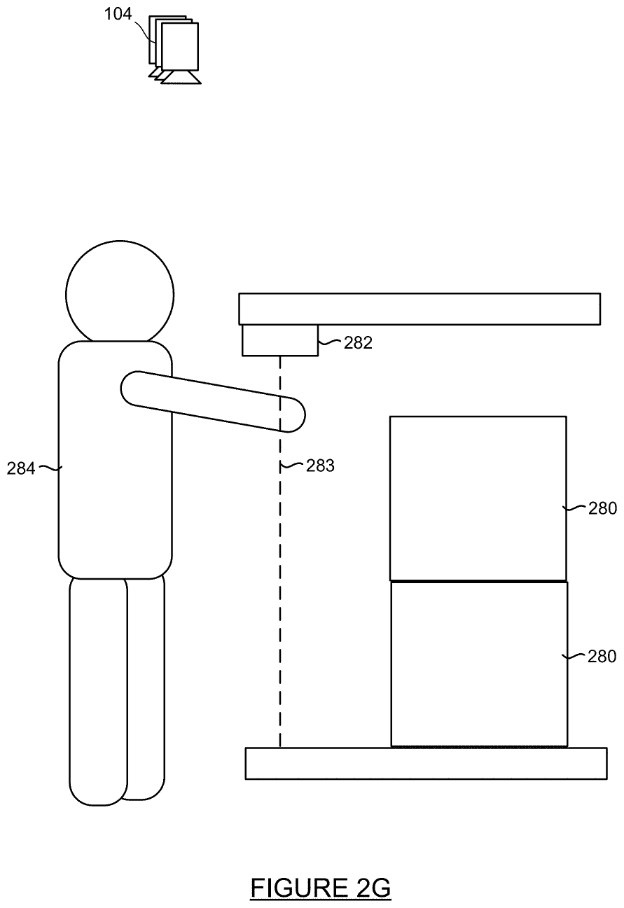

FIG. 2A illustrates an example configuration of a product display unit with designated lanes. A lane is a portion of or a location on a product display unit that is associated with one or more products. For example, lane or location 240, 250, and 260 are associated with the same product and cover the right half of each product display unit. Similarly, lanes (or locations) 210, 220, and 230 are associated with a different product which is located on the left side of product display units 113-115. Lane data may be configured over an image of product display units through an interface provided by the present technology. Data associated with a particular product identifier and the product location or lane may form a planogram, and may be stored locally or remotely. In some instances, an SKU code for each product is stored as part of the product identifier within the planogram.

FIG. 2B illustrates an example configuration of a product display unit with clusters of cameras. The system of FIG. 2B includes camera clusters 104, 105, and 106. Camera cluster 104 includes cameras 104A, 104B, and 104C, camera cluster 105 includes cameras 105A, 105B, and 105C, and camera cluster 106 includes cameras 106A, 106B, and 106C. Each camera cluster may include two or more cameras that are directed at products on a product display unit at different angles. In the embodiment of FIG. 2B, each camera cluster includes three cameras. One camera is positioned directly above and looking downward, and at perpendicular angle to, the product display units holding the shelves. This corresponds to cameras 104B, 105B, and 106B in FIG. 2B. Each cluster in FIG. 2B includes two additional cameras in addition to the perpendicular angled camera. The additional cameras are positioned closely to the perpendicular angled camera, and capture a line of sight that is between 30-45 degrees from the perpendicular angled camera. For example, cameras 104A and 104C may be positioned at +30° and −30° with respect to the center of vision of camera 104B.

With a configuration that involves a cluster of cameras, each product may be captured by at least two cameras, or at least three cameras for example in the illustration of FIG. 2B. As such, video data may be collected for each product from different views. This provides for a stronger set of training data for which to train a model to recognize user selection of the products.

The clusters of cameras may be positioned such that each product is covered by two or more cameras. In some instances, each corresponding camera within a cluster may be positioned at a distance d between each other. For example, in FIG. 2B, cameras 104B and 105B are positioned at a distance d from each other, which may be a distance of 1 meter, 2 meters, 2 feet, 3 feet, or some other distance suitable for covering a position on a product display unit from multiple angles.

FIGS. 2C-2E illustrate cameras that capture a lane from different points of view. The system of FIG. 2C illustrates camera 104C capturing product 270 on product display unit at a first angle. The system of FIG. 2D illustrates camera 105B capturing product 270 at a different angle, for example at an angle perpendicular to the plane of the product display unit on which the product is placed. FIG. 2B illustrates camera 106A capturing product 270 at yet another angle. As shown in FIGS. 2C-2D, mounting camera clusters above products positioned on product display units enables multiple camera views to capture that product can be used as training data.

FIG. 2F illustrates an example configuration of a product display unit that includes cameras and a motion sensor. In some instances, in addition to or in place of a weight sensor 103 on a product display unit such as a shelf, a motion sensor 282 may be positioned to detect a user reaching into a shelf to retrieve a product. In some instances, a motion sensor 282 may be used when a product is larger than other typical products on a shelf or elsewhere in the store. Examples of larger products include packages of paper towels, laundry detergent, and other larger products. As illustrated in FIG. 2F, when a user reaches for product 280, the motion detector 282 detects the user's hand within the sensor range 283. This may in turn trigger video capture from cameras that are directed to that position on the product display unit. In some instances. Both the motion sensor and the cameras may be connected to data collection server 120, which may initiate video capture for a particular lane upon detecting motion, for example motion of a user reaching a hand into a shelf area, in the particular lane. One or more product display units may be configured with any number of motion sensors 282 in 285, as needed to detect a user reaching into reach for a particular product.

FIG. 2G illustrates another example configuration of a product display unit that includes cameras and a motion sensor. As shown in FIG. 2G, user 284 reaches his arm between the product display units to reach a product 280, and is detected by a motion sensor 282 when the user's arm passes the sensor plane 283.

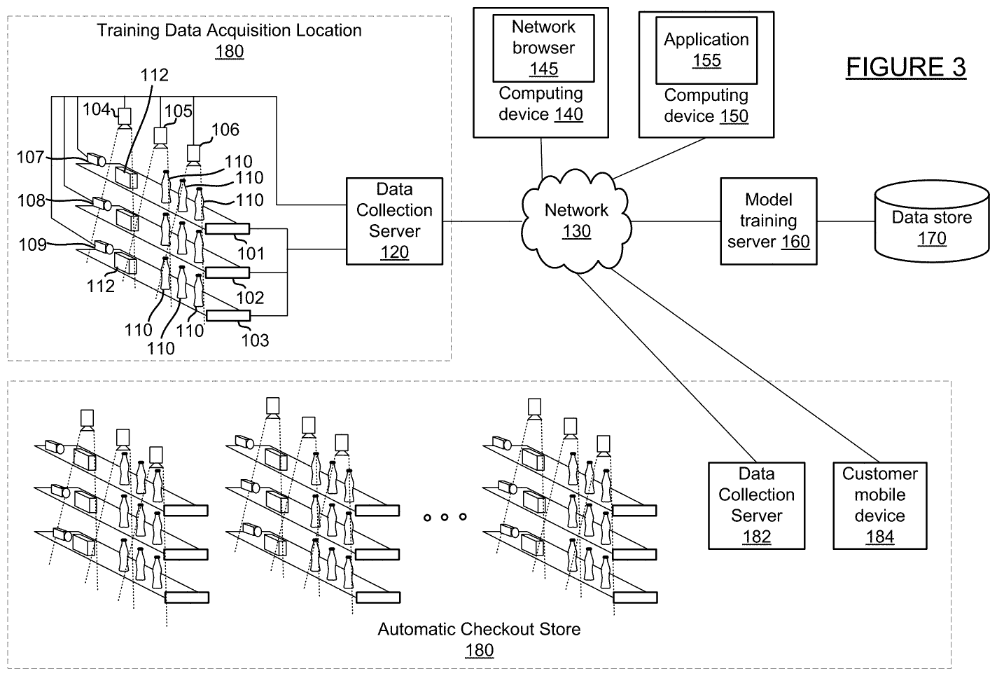

FIG. 3 is a block diagram of a training data acquisition system. The system of FIG. 3 includes training data acquisition location 180, which includes data collection server 120, weight sensing devices 101-103, cameras 104-109, and products 110 and 112. Data collection server 120 may communicate with weight sensing mechanisms 101-103, both to receive weight sensing events and data and to configure and calibrate the weight sensing mechanisms. Data collection server may also communicate with cameras 104-109, in particular to receive video data and to configure the cameras.

FIG. 3 also includes computing devices 140-150, network 130, model training server 160, and data store 170. Each of server 120, devices 140-150, server 160, and data store 170 may communicate over network 130. Network 170 may implement communication between computing devices, data stores, and servers in FIG. 1. Network 130 may include one or more networks suitable for communicating data, including but not limited to a private network, public network, the Internet, an intranet, a wide area network, a local area network, a wireless network, a Wi-Fi network, a cellular network, and a plain old telephone service (POTS).

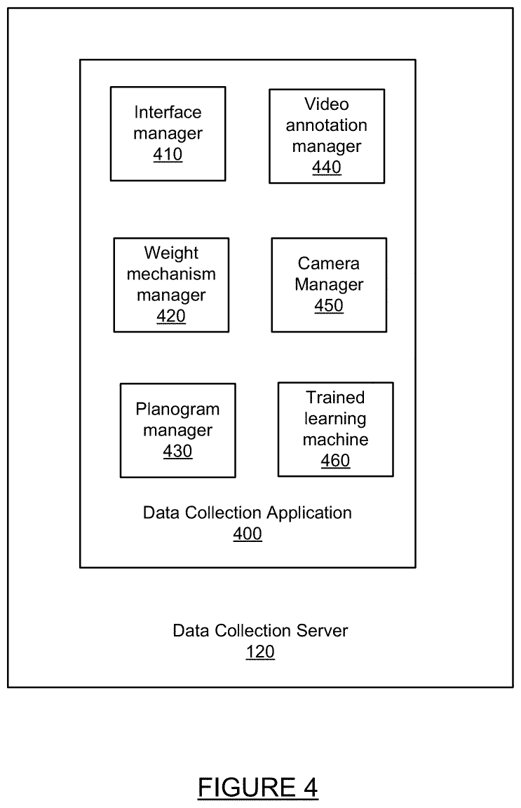

Data collection server 120 may receive data from the multimodal sensors and configure the received data as training data for a learning machine. Data collection server 120 may also provide an interface for configuring weight sensing mechanism sensitivity and camera images, manage a weight mechanism manager, manage cameras, and configure planograms. More details for data collection server 120 are discussed with respect to the system of FIG. 4.

The interfaces provided by data collection server 120 can be viewed by a network browser on computing device 140, an application on computing device 150, as well as other devices. In some instances, network browser 145 may receive content pages and other data from server 120, and provide the content pages to a user through an output of computing device 140. The content pages may provide interfaces, provide output, collect input, and otherwise communicate with a user through computing device 140. Computing device 110 can 140 implemented as a desktop computer, workstation, or some other computing device.

In some instances, the interfaces can be accessed through an application on a computing device, such as application 155. Computing device 150 may include application 155 stored in device memory and executed by one or more processors. In some instances, application 155 may receive data and from a remote server 120, process the data and render output from the raw and processed data, and provide the output to a user through an output of computing device 150.

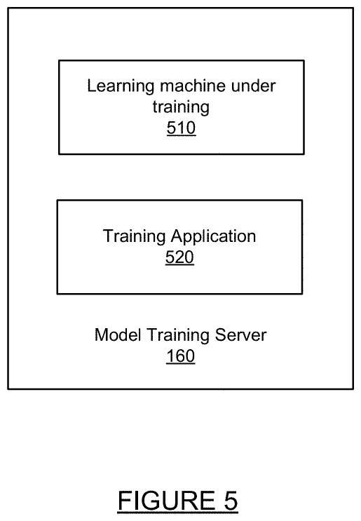

Model training server 160 may receive training data from data collection server 120 and train a learning machine using the received data. In some instances, the learning machine may be a deep learning machine with multiple layers of neural networks. Model training server is discussed in more detail with respect to the system of FIG. 5.

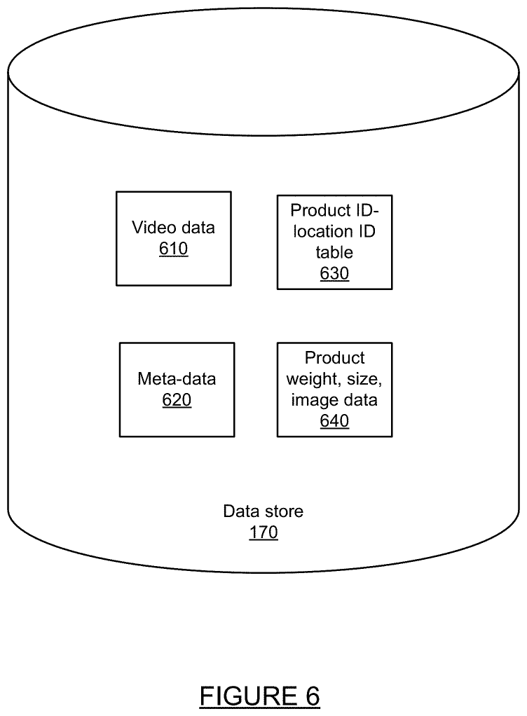

Data store 170 may be in communication with model training server 160 as well as data collection server 120. The data store may include data such as video data, metadata (metadata annotated to video data and other metadata), tables of product identifier and location identifier data, and product data such as the weight, size, and an image of the product, such as for example a thumbnail image. Data store 170 is discussed in more detail with respect to the system of FIG. 6.

Once a model is trained with training data, it may be implemented within an automatic checkout store 180. Weight sensing mechanisms and cameras may be set up in multiple aisles, as illustrated in automatic checkout store 180, and the data collected from these multimodal modal sensors may be processed by a trained learning model on data collection server 182. The trained learning model may detect products retrieved or added to a lane of a product display unit, as well as if a product retrieved from or added to a product display unit is different from a product associated with the particular display unit per the planogram. In any case, when the learning model indicates one or more products have been retrieved from a product display unit, those products are added to a user's cart, and an application on the customer's mobile device 184 identifies the user and the products that are taken by the user while shopping through the automated checkout store 180.

Mobile device 184 may include a mobile application that provides interfaces, output, and receives input as part of implementing the present technology as discussed herein. Mobile device 184 may be implemented as a laptop, cellular phone, tablet computer, chrome book, or some other machine that is considered a “mobile” computing device.

FIG. 4 is a block diagram of a data collection server. Data collection server 120 includes data collection application 400. Application 400 may include an interface manager 410, weight mechanism manager 420, planogram manager 430, video annotation manager 440, camera manager 450, and trained learning machine 460. Interface manager 410 can create interfaces for configuring and calibrating portions of the present system, including weight sensing mechanisms, planogram's, lanes, and other features of the present technology.

Weight mechanism manager 420 may calibrate weight sensing mechanisms, receive data from weight sensing mechanisms, and otherwise communicate and manage mechanisms of the present system.

Planogram manager 430 may generate and configure a planogram in response to user input. For example, a user may provide input through an interface to configure a planogram for a particular product display unit associated with one or more lanes.

Video annotation manager may annotate received video data with additional metadata, such as for example a timestamp, product location, number of products, and other data. Video annotation manager may also determine the number of products retrieved by a retrieving product identifiers and weight information from a remote data store.

Camera manager 450 may configuring communicate with one or more cameras within the present system. Camera manager 450 may also receive video data from one or more cameras.

Trained learning machine 460 may be provided to data collection server 120 after a learning machine has been trained with learning data. The trained learning machine can be used to detect products added to or removed from a product display unit, as well as detecting that a product removed or added to a product display unit does not match a product for that lane as indicated by a planogram.

FIG. 5 is a block diagram of a model training server. The model training server 160 of FIG. 5 includes a training application 520 and a learning machine under training 510. Training application 520 may train the learning machine 510 based on training data received from a data collection server. Once trained, model training server 160 may distribute the learning machine to remote data collecting servers.

FIG. 6 is a block diagram of a data store. Data store 170 may include video data 610, metadata 620, product identifier and location identifier tables 630, and data for a product weight, size, and image. Video data may include sets of data from one or more cameras used to capture video of a product being added or removed to a product display unit.

Meta-data 620 may include data annotated to the received video data and/or other data, including but not limited to weight data, product quantity, timestamp, lane or location data, and other data.

A table of product identifiers and location identifiers can be searched by remote applications to determine what product is associated with a particular location at which a weight event has occurred. Product weight, size, and image data may be used to populate one or more interfaces when configuring or providing information about a particular product.

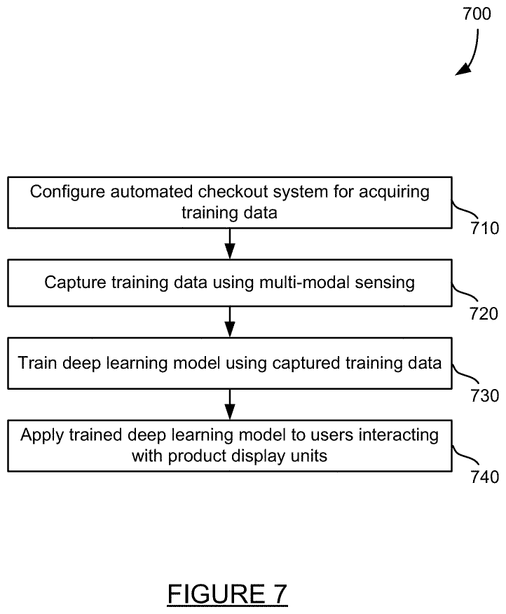

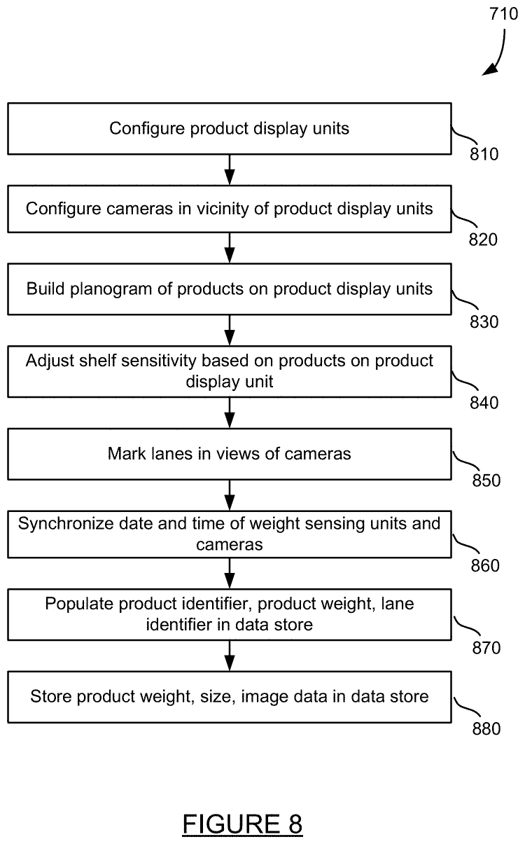

FIG. 7 is a method for acquiring training data for an automatic checkout system. The method of FIG. 7 begins with configuring an automated checkout system for acquiring training data. Configuring a system for acquiring training data may include configuring the multimodal sensors, marking lanes, and other actions. More detail for step 710 is discussed with respect to the method of FIG. 8.

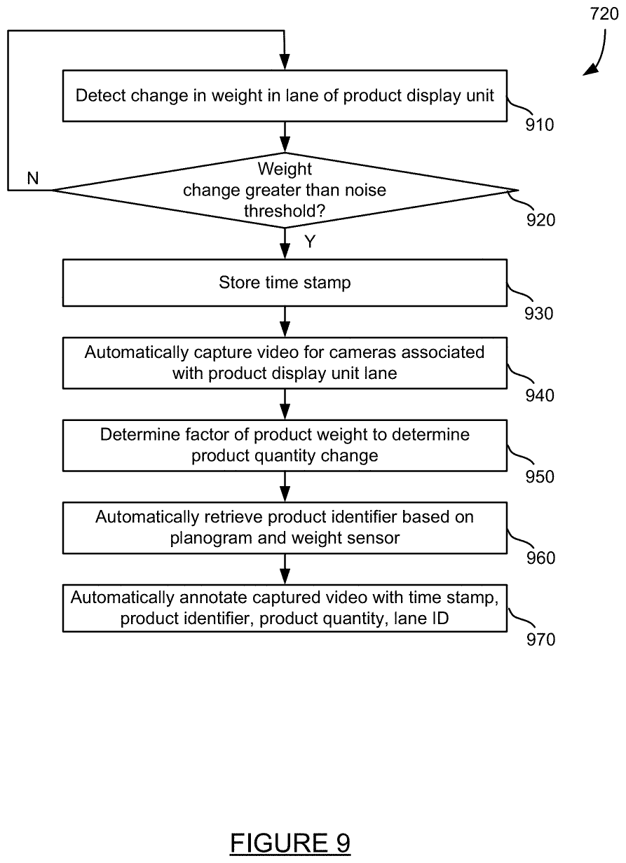

Training data is captured using multimodal sensors at step 720. Capturing the training data may include detecting a change in weight, storing timestamps, and automatically capturing video. Capturing training data is discussed in more detail with respect to the method of FIG. 9.

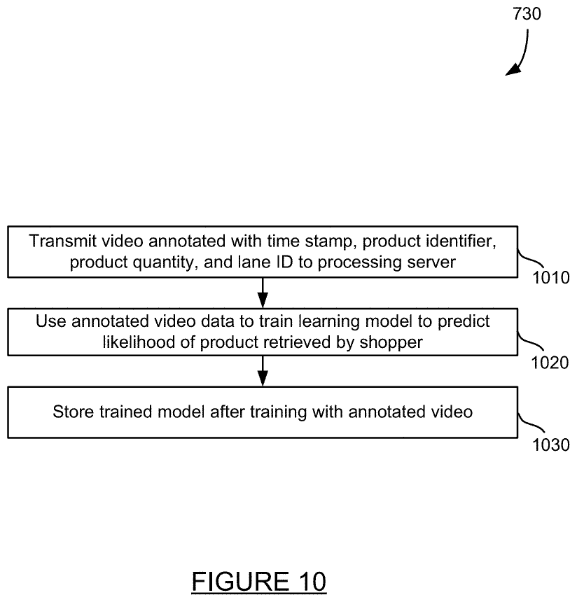

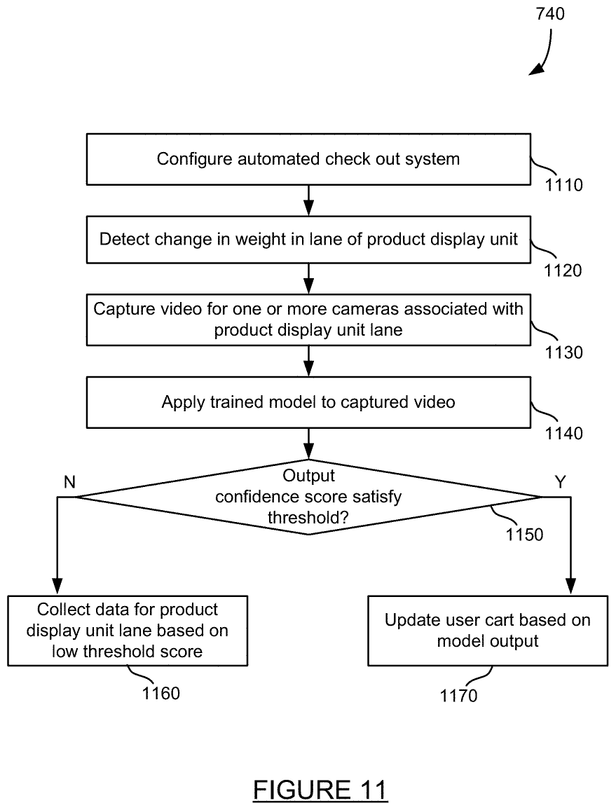

A deep learning model is trained using the captured training data at step 730. The trained deep learning model may then be applied to users interacting with product display units at step 740. More detail for training a learning model and applying a training model are discussed with respect to FIGS. 10 and 11, respectively.

FIG. 8 is a method for configuring an automated checkout system for acquiring training data. The method of FIG. 8 provides more detail for step 710 of the method of FIG. 7. First, product display units may be configured with products at step 810. In some instances, products having different weights or appearances may be placed on the product display units, in anticipation of assigning the different products with lanes or location information. Next, cameras in the vicinity of the product display units are configured at step 820. The cameras may be configured to be in proper focus, point in the right direction, and other configuration steps.

A planogram is then built for products on the product display units at step 830. The planogram may specify which products are on which locations on the product display units. The planogram data can be stored in a remote data store, locally, or both. Shelf sensitivity may then be adjusted based on products positioned on the product display unit at step 840. The shelf sensitivity can be adjusted through an interface, mechanically, or in some other manner. The sensitivity can be set such that the way to sensing devices on the product display units can detect when a product on those display units is removed or added.

Lanes can be marked in views of one or more cameras at step 850. The lanes can be marked in images provided through an interface of the present system. The lanes may specify one or more products on particular positions within the product display unit.

The date and time can be synchronized between the weight sensing units and cameras at step 860. In some instances, the time synchronization can be performed using a network timing protocol synchronization. A product identifier, product weight, and lane identifier can be populated in a data store at step 870. The data may be sent to the data store for storage by data collection server 120, model train server 160, or both. The product weight, size, and image data may be stored in a data store at step 880. The product weight, size and image data, such as for example a thumbnail image, can be retrieved for display in one or more interfaces for managing the present system, such as for example inventory tracking, planogram generation, lane annotation, and other operations.

FIG. 9 is a method for capturing training data using multi modal sensing. The method of FIG. 9 provides more detail for step 720 of the method of FIG. 7. A change is detected in weight within a lane of a product display unit at step 910. A determination is then made as to whether the weight change is greater than a noise threshold at step 920. If the weight change is not greater than the noise threshold, then the weight change can be ignored and the system continues to sense weight changes at step 910. If the weight change is greater than a noise threshold at step 920, a timestamp is stored at step 930. Video is then automatically captured for cameras associated with the product display unit lane at step 940. The video capture is triggered in response to detecting the weight change by the weight sensing mechanism.

The factor of the product weight is determined to identify quantity of products taken from the product display unit at step 950. For example, if the change in weight is twice the weight of a product, then two units of the product have been taken. A product identifier may be automatically retrieved based on the planogram and wait sensor at step 960. When the particular product display unit and the change in weight is known, the planogram can be used to retrieve the product identifier from a remote database. The captured video that may then be automatically annotated with the timestamp, product identifier, product quantity, and lane ID at step 970.

FIG. 10 is a method for training a deep learning model using captured training data. The method of FIG. 10 provides more detail for step 730. Video annotated with the timestamp, product identifier, product quantity and lane ID may be transmitted to the processing server at step 1010. The annotated video data may then be used to train a learning model to predict the likelihood of a product retrieved by a shopper at step 1020. After training, the training model can be stored at step 1030. The training model that can then be used for real-life situations when shoppers are taking or returning products to product display units similar to those used in training the learning model.

FIG. 11 is a method for applying a trained deep learning model to video of users interacting with product display units. The method of FIG. 11 provides more detail for step 740 the method of FIG. 7. First, an automated checkout system is configured at step 1110. A change in weight is detected in a lane of a product displaying unit at step 1120 video can be captured for one or more cameras associated with the product display unit lane at step 1130. The trained model can then be applied to the captured video. A determination is then made as whether the confidence score output by the trained model satisfies a threshold that step 1150. If the apple confidence score does not satisfy the threshold, then it is uncertain if the product retrieved are added is actually the product that should be placed on the product display unit according to the planogram. To identify more information about the product, data is collected for the product display unit lane based on the low threshold score at step 1160. If the upper confidence score does satisfy the threshold, a user cart may be updated based on the model output at step 1170.

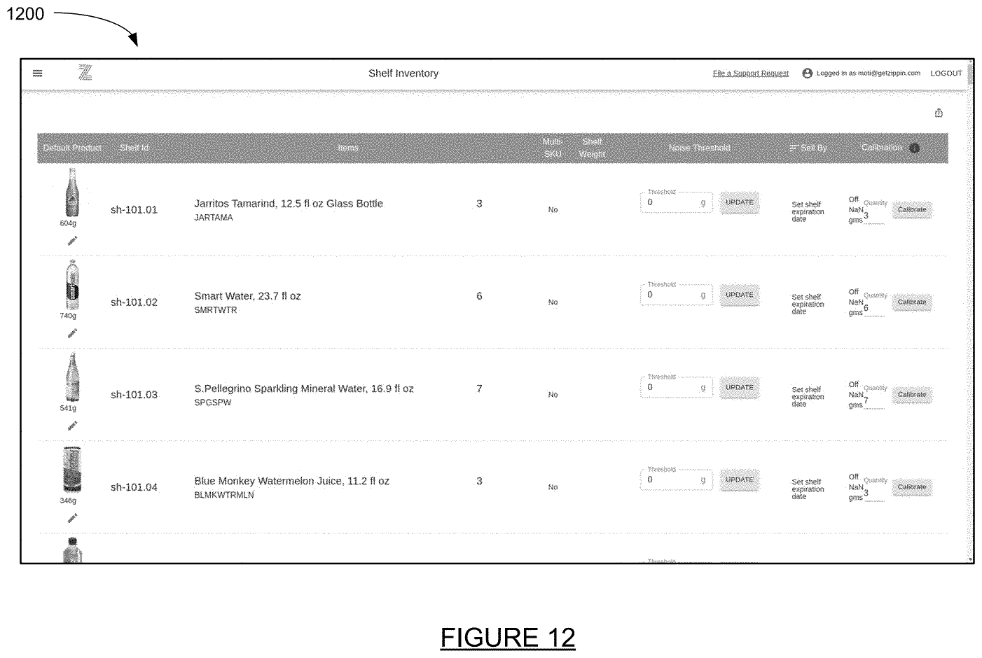

FIG. 12 is a screenshot of a dashboard for building a planogram. The interface 1200 of FIG. 12 provides information for products displayed in certain positions on product display units. The information for each product includes an image of the product, a product display unit identifier, a description of the product, the quantity of the product, a noise threshold for the product, a cell by date for the product, and calibration data for the product. The position on the product display unit corresponds to the lane, thereby providing the planogram data for the product. For example, in the second row of interface 1200, an image for “smart water” is shown, with a shelf ID of sh-101.02, a description of the smart water product that indicates it is 22.7 fluid ounces, an indication that there are six products at the lane location, an indication that there is no threshold or sell by date, and a calibration indicator that there are six units of the product at the particular lane.

In some instances, the interface may receive a weight and a thumbnail image of each product. The weight of the product may be determined, for example, by determining an average weight over several weight measurements for the product, such as for example 10, 15, or some other number of weight measurements taken from a weight scale.

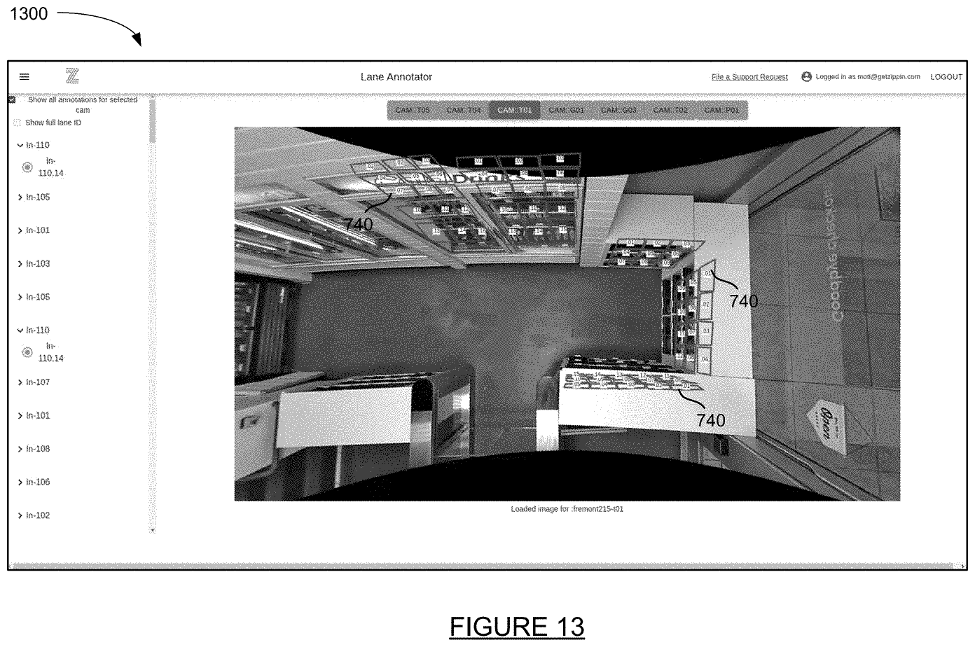

FIG. 13 is a screenshot of an interface for marking lanes via annotation. The interface 1300 of FIG. 13 shows an image captured by an overhead camera of product display units implemented as shelves and refrigerators. Within the refrigerators and the shelves, lanes 740 are identified by annotations made within the image. The interface allows a user to increase or decrease, as well as change the locations of, the indicators comprising a particular lane on a product display unit. Additionally, a user may select different cameras for which to configure lane data. Currently, a camera with a name of “CAM::T01” is selected and being configured with lane data.

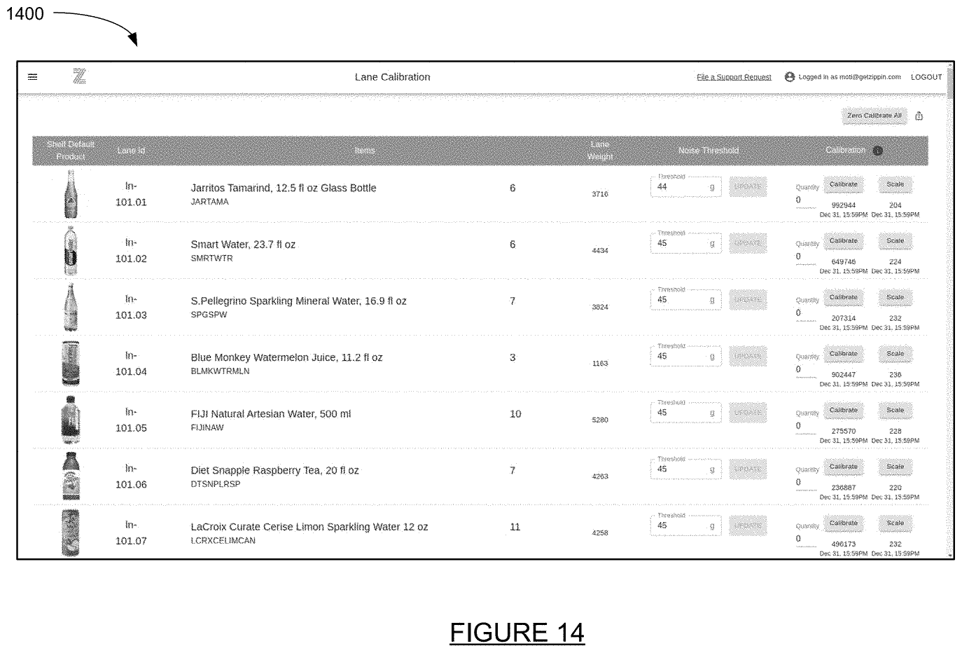

FIG. 14 is a screenshot of a dashboard for calibrating product display unit sensitivity. The interface 1400 of FIG. 14 provides information for products, and in particular for calibrating the weight sensitivity required for the product. For example, in the second row interface 1400, for a “Smart Water” product, a noise threshold of 45 is entered, a lane weight of 4434 is entered, a calibration value is provided of 649746, and a scale of 224.

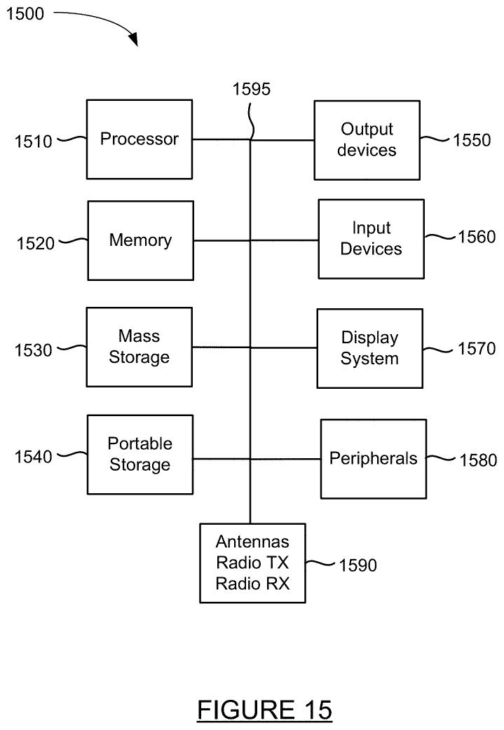

FIG. 15 is a block diagram of an environment for implementing the present technology. System 1500 of FIG. 15 may be implemented in the contexts of the likes of machines that implement computing severs 120, 160, and 182, devices 140, 150, and 184, and data store 170. The computing system 1500 of FIG. 15 includes one or more processors 1510 and memory 1520. Main memory 1520 stores, in part, instructions and data for execution by processor 1510. Main memory 1520 can store the executable code when in operation. The system 1500 of FIG. 15 further includes a mass storage device 1530, portable storage medium drive(s) 1540, output devices 1550, user input devices 1560, a graphics display 1570, and peripheral devices 1580.

The components shown in FIG. 15 are depicted as being connected via a single bus 1590. However, the components may be connected through one or more data transport means. For example, processor unit 1510 and main memory 1520 may be connected via a local microprocessor bus, and the mass storage device 1530, peripheral device(s) 1580, portable storage device 1540, and display system 1570 may be connected via one or more input/output (I/O) buses.

Mass storage device 1530, which may be implemented with a magnetic disk drive, an optical disk drive, a flash drive, or other device, is a non-volatile storage device for storing data and instructions for use by processor unit 1510. Mass storage device 1530 can store the system software for implementing embodiments of the present invention for purposes of loading that software into main memory 1520.

Portable storage device 1540 operates in conjunction with a portable non-volatile storage medium, such as a floppy disk, compact disk or Digital video disc, USB drive, memory card or stick, or other portable or removable memory, to input and output data and code to and from the computer system 1500 of FIG. 15. The system software for implementing embodiments of the present invention may be stored on such a portable medium and input to the computer system 1500 via the portable storage device 1540.

Input devices 1560 provide a portion of a user interface. Input devices 1560 may include an alpha-numeric keypad, such as a keyboard, for inputting alpha-numeric and other information, a pointing device such as a mouse, a trackball, stylus, cursor direction keys, microphone, touchscreen, accelerometer, and other input devices. Additionally, the system 1500 as shown in FIG. 15 includes output devices 1550. Examples of suitable output devices include speakers, printers, network interfaces, and monitors.

Display system 1570 may include a liquid crystal display (LCD) or other suitable display device. Display system 1570 receives textual and graphical information and processes the information for output to the display device. Display system 1570 may also receive input as a touchscreen.

Peripherals 1580 may include any type of computer support device to add additional functionality to the computer system. For example, peripheral device(s) 1580 may include a modem or a router, printer, and other device.

The system of 1500 may also include, in some implementations, antennas, radio transmitters and radio receivers 1590. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1500 of FIG. 15 are those typically found in computer systems that may be suitable for use with embodiments of the present invention and are intended to represent a broad category of such computer components that are well known in the art. Thus, the computer system 1500 of FIG. 15 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for acquiring training data of products for automated checkout, the method comprising:
receiving a plurality of weight values by a computing device and from a weight sensing mechanism coupled to a product display unit, each of the plurality of weight values associated with a time stamp and a change in the number of products stored on the product display unit;
receiving a plurality of video data sets by the computing device and from one or more cameras, each video data set having a time stamp that is synchronized with one of the weight value time stamps, and each video data set capturing the location on the product display unit that is associated with the change in the number of products stored on the display unit, wherein each video data set is captured by three or more cameras, a first camera of the three or more cameras directed directly over the products, a second camera of the three cameras directed at an angle of between 30-45 degrees away from a perpendicular angle to the product display unit and directed towards the products from a first side of the first camera, a third camera of the three cameras directed at an angle of between 30-45 degrees away from a perpendicular angle to the product display unit and directed towards the products from a second side of the first camera; and
determining, by the computing device and for each weight value, the quantity of products removed or added to the display unit based at least in part on the weight value,
wherein the plurality of weight values, plurality of video data sets, and product quantities removed or added are intended to be used for training a learning machine.

2. The method of claim 1, wherein video capture by the one or more cameras is initiated for the location on the product display unit in response to detecting a change in weight at the product display unit location, the weight value corresponding to the change in weight.

3. The method of claim 1, further comprising:
accessing a location identifier for the shelf for which the weight value was detected; and
retrieving an identifier for a product associated with the location identifier,
the product identifier to be used for training the learning machine with the plurality of weight values, plurality of video data sets, and product quantities.

4. The method of claim 1, wherein the one or more cameras and the weight sensing mechanism are time synchronized using NTP.

5. The method of claim 1, wherein each weight value is a multiple of a weight of a product stored on the product display unit.

6. The method of claim 1, wherein the learning machine has multiple layers of neural networks.

7. The method of claim 1, wherein the weight values are associated a change in weight applied to the product display unit when one or more products are added to or removed from the product display unit.

8. The method of claim 1, wherein the one or more cameras include a first camera displaced above the product and a second camera mounted on the product display unit.

9. The method of claim 1, further comprising:
providing an image of the product display unit through an interface; and
receiving input through the interface to associate a product identifier with a location on the product display unit as displayed in the image.

10. The method of claim 1, wherein the weight of the product is entered by measuring the average weight of the product as collected by placing the product on a weighing scale.

11. The method of claim 1, wherein each set of three cameras is spaced between 1-2 meters apart.

12. The method of claim 1, further comprising a motion sensor displaced on a product display unit or on the ceiling near the shelf, wherein the motion sensor detects a user reaching for a product, the motion sensor triggering video capture by at least one camera upon detecting motion.

13. The method of claim 12, further comprising:
processing video continuously by a computing device, the processing including performing motion computation, the motion sensing performed by processing one or more video feeds from a motion camera, the motion camera providing video data to the computing device;
detecting a user reaching for a product based on the motion computation; and
triggering video capture of the product the user is reaching for through at least one camera.

14. The method of claim 13 wherein the motion camera is placed between 0.1 meters to 2 meters from the display unit edge facing the aisle.

15. The method of claim 1, further comprising:
providing an image of the product display unit through an interface; and
receiving input through the interface to annotate locations on the product display unit as displayed in the image.

16. The method of claim 1, wherein the plurality of weight values, plurality of video data sets, and product quantities are transmitted to a remote server, the remote server using the received plurality of weight values, plurality of video data sets, and product quantities to train a learning machine having one or more neural networks to predict an identification and quantity of products removed from the product display unit.

17. The method of claim 1, further comprising:
applying a subsequently captured video data set to a learning machine trained with the plurality of weight values, plurality of video data sets, and product quantities.
receiving an output from the trained learning machine that is below a threshold value; and
recapturing data, based on the output below the threshold, of the product associated with subsequent video data set.

18. A non-transitory computer readable storage medium having embodied thereon a program, the program being executable by a processor to acquiring training data of products for automated checkout, the method comprising:
receiving a plurality of weight values by a computing device and from a weight sensing mechanism coupled to a product display unit, each of the plurality of weight values associated with a time stamp and a change in the number of products stored on the product display unit;
receiving a plurality of video data sets by the computing device and from one or more cameras, each video data set having a time stamp that is synchronized with one of the weight value time stamps, and each video data set capturing the location on the product display unit that is associated with the change in the number of products stored on the display unit; and
determining, by the computing device and for each weight value, the quantity of products removed or added to the display unit based at least in part on the weight value,
wherein the plurality of weight values, plurality of video data sets, and product quantities removed or added are intended to be used for training a learning machine.

17. The non-transitory computer readable storage medium of claim 16, wherein video capture by the one or more cameras is initiated for the location on the product display unit in response to detecting a change in weight at the product display unit location, the weight value corresponding to the change in weight.

20. A system for acquiring training data of products for automated checkout, comprising:
a server including a memory and a processor; and
one or more modules stored in the memory and executed by the processor to receive a plurality of weight values by a computing device and from a weight sensing mechanism coupled to a product display unit, each of the plurality of weight values associated with a time stamp and a change in the number of products stored on the product display unit. receive a plurality of video data sets by the computing device and from one or more cameras, each video data set having a time stamp that is synchronized with one of the weight value time stamps, and each video data set capturing the location on the product display unit that is associated with the change in the number of products stored on the display unit, determine, by the computing device and for each weight value, the quantity of products removed or added to the display unit based at least in part on the weight value, wherein the plurality of weight values, plurality of video data sets, and product quantities removed or added are intended to be used for training a learning machine.
